(19) United States
(12) Patent Application Publication
(10) Pub. No.: US 2026/0063111 A1
(43) Pub. Date: Mar. 5, 2026

(54) Anti-Icing Device for Blade of Wind Turbine Generator System, and Anti-Icing Method

(71) Applicant: Huaneng Jiuquan Wind Power Co., Ltd., Jiuquan (CN)

(72) Inventors: Yanzhi LI, Jiuquan (CN); Peixuan WU, Jiuquan (CN); Nanbo MENG, Jiuquan (CN); Shanbin SU, Jiuquan (CN); Xuefeng LIU, Jiuquan (CN)

(21) Appl. No.: 19/385,480

(22) Filed: Nov. 11, 2025

Related U.S. Application Data
(63) Continuation of application No. PCT/CN2025/114986, filed on Aug. 15, 2025.

(30) Foreign Application Priority Data
Aug. 30, 2024 (CN) 202411209302.X

(51) Int. Cl. F03D 80/40

(52) U.S. Cl. CPC F03D 80/403; F05B 2260/422

(57) ABSTRACT

Disclosed is an anti-icing device for a blade of a wind turbine generator system, which relates to the technical field of wind turbine generator systems. The device includes a vibration unit and an excitation unit. The vibration unit includes a mounting seat, a vibration assembly, and a support column. The excitation unit includes an excitation assembly, a drive assembly, an energy storage assembly, and a snap-fit assembly. The anti-icing device for a blade of a wind turbine generator system can be mounted conveniently and does not require extra power as a driving energy source.

### CROSS-REFERENCE TO RELATED APPLICATIONS

The present application is a continuation of International Application No. PCT/CN2025/114986, filed on Aug. 15, 2025, and claims priority to Chinese Patent Application No. 202411209302.X, filed on Aug. 30, 2024, the entire disclosure of which is incorporated herein by reference.

### TECHNICAL FIELD

The present disclosure relates to the technical field of wind turbine generator systems, and in particular, to an anti-icing device for a blade of a wind turbine generator system, and an anti-icing method.

### BACKGROUND

The harm of icing of blades of a wind turbine generator system mainly includes reduction in power generation efficiency, increase in mechanical wear, and increase in safety hazards. Specifically, since the icing on the blades will increase the weights and resistance of the blades, the reduction in power generation efficiency of the wind turbine generator system is caused. In addition, the icing will also change the aerodynamic performance of the blades, make the output power of the wind turbine generator system unstable, and affect the stable operation of a power grid. Since the icing on the blades will result in greater loads on mechanical parts of the wind turbine generator system, the mechanical wear and damage are increased. In addition, the normal operation of the wind turbine generator system is affected, and maintenance costs are increased. The icing on the blades will increase the safety hazards of the wind turbine generator system. Under extreme weather conditions, the icing probably lead to serious consequences such as blade fracture and system collapse, which poses a threat to human life and property security. Moreover, the icing also probably leads to a great difference between a measured value of an anemometer and the actual wind speed, and further leads to the error of operational measurement data and the change in aerodynamic features of wind turbines. For example, due to uneven mass distribution of the blades, the aerodynamic noise becomes stronger, which will affect the lives of nearby residents in serious cases.

However, in the prior art, a physical anti-icing device based on vibration requires extra power as driving force, and needs to consider mounting and wiring since the blades are in a relatively rotating state.

### SUMMARY

In order to solve the problems of an existing anti-icing device for a blade of a wind turbine generator system, the present disclosure is provided.

Thus, the present disclosure provides an anti-icing device for a blade of a wind turbine generator system for solving the technical problem that extra power is required as driving force, and mounting and wiring are needed to considered since blades are in a relatively rotating state.

In order to solve the technical problem, the present disclosure provides a technical solution as follows: an anti-icing device for a blade of a wind turbine generator system, used for clearing ice on a wind turbine unit, including:
a vibration unit including a mounting seat arranged on the wind turbine unit, a vibration assembly arranged on the mounting seat, and a support column arranged on the mounting seat; and
an excitation unit including an excitation assembly rotatably arranged on the support column and abutting against the vibration assembly, a drive assembly rotatably arranged on the support column, an energy storage assembly that is rotatably arranged on the support column and of which two ends are connected to the excitation assembly and the drive assembly respectively, and a snap-fit assembly of which one end is rotatably arranged on the support column and the other end is snap-fitted with the excitation assembly.

As a preferred solution of the anti-icing device for a blade of a wind turbine generator system of the present disclosure, the wind turbine unit includes a support seat, a rotation seat rotatably arranged on the support seat, and a blade arranged on the rotation seat and used for mounting the mounting seat.

As a preferred solution of the anti-icing device for a blade of a wind turbine generator system of the present disclosure, the vibration assembly includes a connection seat abutting against the blade and snap-fitted with the mounting seat, a vibration spring of which one end is arranged on the connection seat, and a counterweight ball arranged on the other end of the vibration spring.

As a preferred solution of the anti-icing device for a blade of a wind turbine generator system of the present disclosure, the excitation assembly includes a first rotation sleeve rotatably arranged on the support column and snap-fitted with the snap-fit assembly, a first support rod of which one end is arranged on the first rotation sleeve, and a hit hammer arranged on the other end of the first support rod and abutting against the counterweight ball.

As a preferred solution of the anti-icing device for a blade of a wind turbine generator system of the present disclosure, the drive assembly includes a second rotation sleeve rotatably arranged on the support column, a second support rod of which one end is arranged on the second rotation sleeve, and a counterweight block arranged on the other end of the second support rod.

As a preferred solution of the anti-icing device for a blade of a wind turbine generator system of the present disclosure, the energy storage assembly includes a constant-force spring arranged on a peripheral side of the support column and located between the excitation assembly and the drive assembly, a second snap-fit column arranged on an end, closest to an inner side, of the constant-force spring and connected to the first rotation sleeve, and a first snap-fit column arranged on the other end of the constant-force spring and slidably connected to the second rotation sleeve.

As a preferred solution of the anti-icing device for a blade of a wind turbine generator system of the present disclosure, a mounting recess for accommodating the snap-fit assembly is provided in the support column, a snap-fit recess in which the snap-fit assembly is snap-fitted is provided in the first rotation sleeve, the snap-fit assembly includes a snap-fit strip of which one end is arranged in the mounting recess and the other end protrudes from the mounting recess and that abuts against the snap-fit recess, a first elastic member arranged in the mounting recess and abutting against the snap-fit strip, and a pin arranged on the snap-fit strip and rotatably connected to the support column, and the snap-fit strip is located in the constant-force spring and abuts against the constant-force spring.

As a preferred solution of the anti-icing device for a blade of a wind turbine generator system of the present disclosure, a connection assembly is arranged between the energy storage assembly and the second rotation sleeve, and the connection assembly includes a rotation plate rotatably arranged on the support column and slidably connected to and abutting against the first snap-fit column, two groups of anti-reverse teeth meshing with and arranged on the rotation plate, a baffle arranged on the first snap-fit column, and a second elastic member that is arranged on the first snap-fit column and of which two ends are connected to the baffle and the rotation plate respectively.

As a preferred solution of the anti-icing device for a blade of a wind turbine generator system of the present disclosure, a slot for embedding the second snap-fit column is provided in the first rotation sleeve.

The present disclosure has the following beneficial effects: a requirement for the extra power as the driving force is solved by using self-gravity of the drive assembly as a power source, and the technical problem that the mounting and the wiring are needed to considered since the blades are in the relatively rotating state can be solved without the power.

In order to solve the problems of the existing anti-icing device for a blade of a wind turbine generator system, the present disclosure is provided.

Thus, the present disclosure provides an anti-icing method for solving the technical problem that the extra power is required as the driving force.

In order to solve the technical problem, the present disclosure provides a technical solution as follows: applied to the anti-icing device for a blade of a wind turbine generator system described above, the method includes:
mounting a mounting seat on a blade, and making a vibration assembly abuts against the blade;
rotating, when the blade rotates, a drive assembly relative to a support column since a center of gravity of the drive assembly is always downward;
making an excitation assembly stuck by a snap-fit assembly, displacing and rotating the excitation assembly along with the support column, and driving, by the drive assembly, an energy storage assembly to store energy;
making the energy storage assembly elastically contract and deform when the energy storage assembly stores the energy, pressing the snap-fit assembly by the energy storage assembly, and displacing and separating the snap-fit assembly from the excitation assembly;
releasing, when the snap-fit assembly releases the excitation assembly from limit, the energy stored by the energy storage assembly through the excitation assembly, and enabling the excitation assembly to rotate;
hitting, by the excitation assembly when the excitation assembly rotates, the vibration assembly, making the vibration assembly generate vibration, transmitting the vibration to the blade, vibrating the blade synchronously, achieving an anti-icing objective, shattering ice block when icing occurs, and making the ice block fall off conveniently;
making, when the energy storage assembly releases the energy, the energy storage assembly elastically expands and deforms, making the snap-fit assembly bounce and continue to limit the excitation assembly, and making the energy storage assembly capable of continuously performing storage; and
repeating the steps, implementing automatic vibration triggering, and automatically performing a physical anti-icing operation by relying on gravitational potential energy generated when the blade rotates.

The present disclosure has the following beneficial effects: the technical problem of a requirement for the extra power as the driving force is solved by using self-gravity of the drive assembly as a power source.

### BRIEF DESCRIPTION OF DRAWINGS

To describe technical solutions of examples of the present disclosure more clearly, accompanying drawings required for description of the examples will be briefly described below. Apparently, the accompanying drawings in the following description show merely some examples of the present disclosure, and a person of ordinary skill in the art can still derive other accompanying drawings from these accompanying drawings without creative efforts.

FIG. 1 is a schematic overall structural diagram of an anti-icing device for a blade of a wind turbine generator system according to the present disclosure.

FIG. 2 is a schematic partial structural diagram of an anti-icing device for a blade of a wind turbine generator system according to the present disclosure.

FIG. 3 is a schematic structural diagram of a vibration unit in an anti-icing device for a blade of a wind turbine generator system according to the present disclosure.

FIG. 4 is a partial structural sectional view of an anti-icing device for a blade of a wind turbine generator system according to the present disclosure.

FIG. 5 is an enlarged schematic diagram at A in FIG. 4.

FIG. 6 is an enlarged schematic diagram at B in FIG. 4.

FIG. 7 is a partial structural exploded view of an anti-icing device for a blade of a wind turbine generator system according to the present disclosure.

FIG. 8 is an enlarged schematic diagram at C in FIG. 7.

FIG. 9 is an enlarged schematic diagram at D in FIG. 7.

FIG. 10 is a schematic structural diagram of a snap-fit assembly in an anti-icing device for a blade of a wind turbine generator system according to the present disclosure.

Description of figures: 100. wind turbine unit; 101. support seat; 102. rotation seat; 103. blade; 200. vibration unit; 201. mounting seat; 202. vibration assembly; 202a. connection seat; 202b. vibration spring; 202c. counterweight ball; 203. support column; 203a. mounting recess; 300. excitation unit; 301. excitation assembly; 301a. hit hammer; 301b. first support rod; 301c. first rotation sleeve; 301c-1. snap-fit recess; 301c-2. slot; 301c-3. bearing recess; 302. energy storage assembly; 302a. constant-force spring; 302b. first snap-fit column; 302c. second snap-fit column; 303. drive assembly; 303a. counterweight block; 303b. second support rod; 303c. second rotation sleeve; 304. snap-fit assembly; 304a. snap-fit strip; 304b. first elastic member; 304c. pin; 305. connection assembly; 305a. rotation plate; 305b. anti-reverse tooth; 305c. second elastic member; and 305d. baffle.

### DETAILED DESCRIPTION OF THE EMBODIMENTS

To make the objectives, features and advantages of the present disclosure clearer and more comprehensible, specific embodiments of the present disclosure will be described below in detail with reference to accompanying drawings of the description.

Many specific details are set forth in the following description to facilitate full understanding of the present disclosure, but the present disclosure can further be implemented in another method different from those described herein. Similar extension can be made by those skilled in the art without departing from the contents of the present disclosure, and the present disclosure is not limited by the specific examples disclosed below accordingly.

Secondly, “one example”, “an example”, or “the example” referred to herein indicates a specific feature, structure or characteristic that can be included in at least one implementation of the present disclosure. The “in an example” or “in one example” throughout this description does not indicate the same example, nor a separate or selective example mutually exclusive of other examples.

Then, the present disclosure will be described in detail with reference to the schematic diagram. When the example of the present disclosure is described in detail, a sectional view showing a device structure will not be partially enlarged in general proportion for the convenience of description, and the schematic diagram is merely illustrative, and should not limit the protection scope of the present disclosure herein. In addition, three-dimensional spatial dimensions of a length, a width, and a depth should be included in actual production.

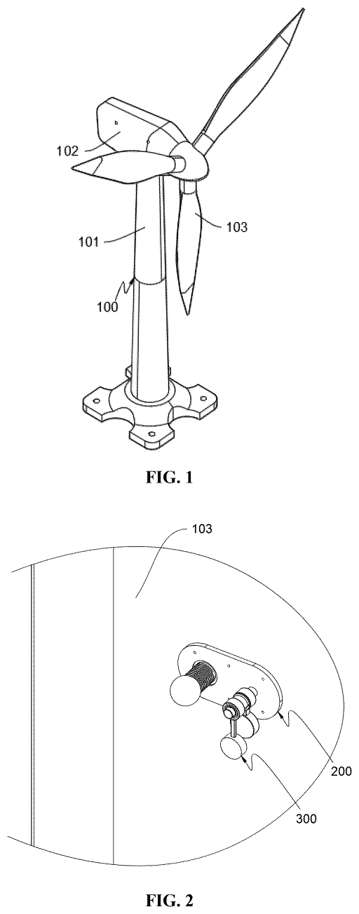

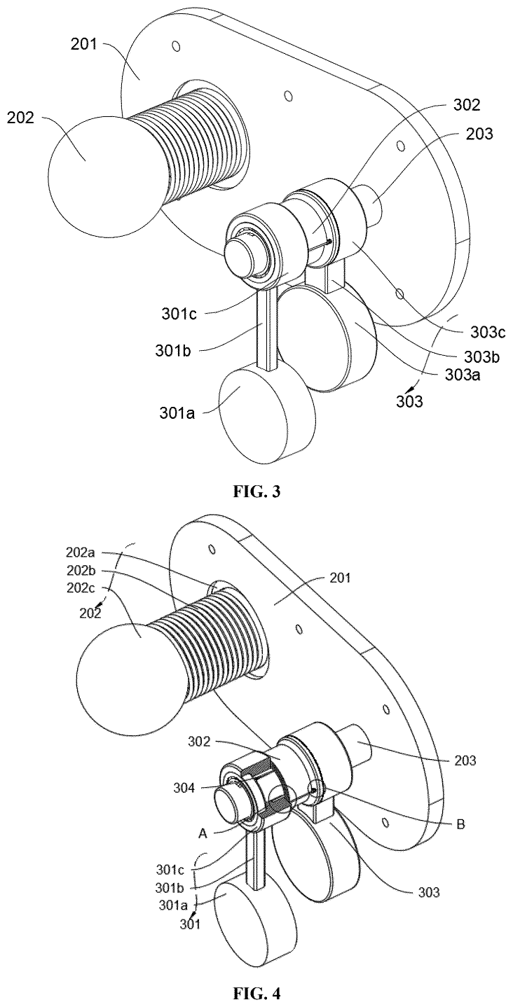

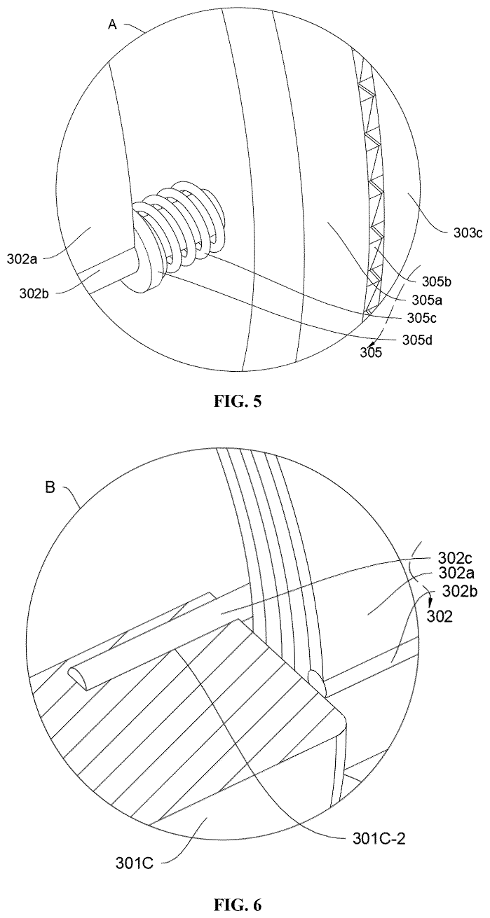

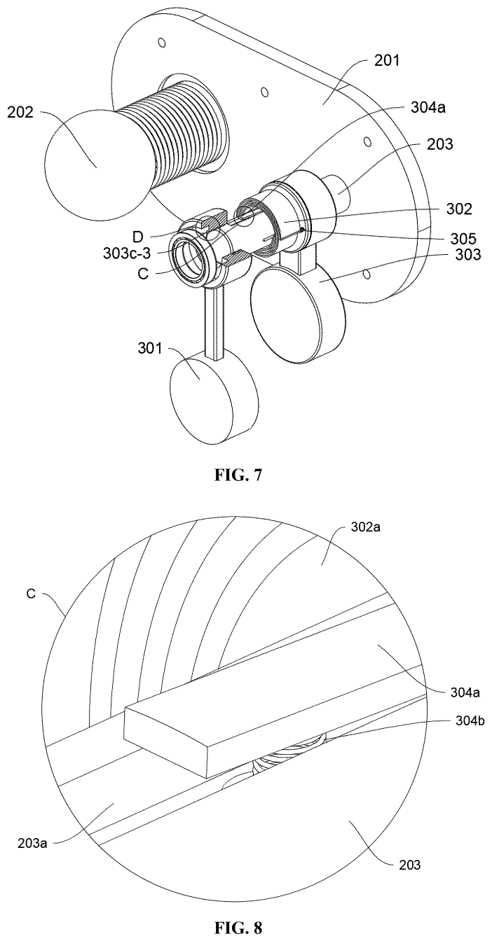

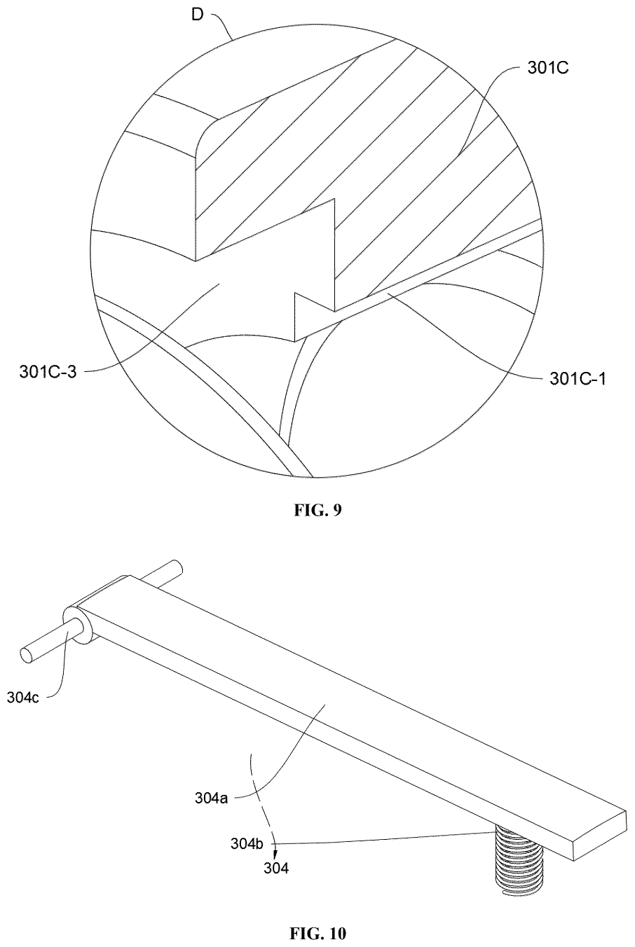

In Example 1 as a first example of the present disclosure, with reference to FIG. 1 to FIG. 10, an anti-icing device for a blade of a wind turbine generator system is provided and is used for clearing ice on a wind turbine unit 100. The wind turbine unit 100 includes a support seat 101, a rotation seat 102 rotatably arranged on the support seat 101, and a blade 103 arranged on the rotation seat 102 and used for mounting a mounting seat 201.

The device includes a vibration unit 200 and an excitation unit 300.

The vibration unit 200 includes the mounting seat 201 arranged on the wind turbine unit 100, a vibration assembly 202 arranged on the mounting seat 201, and a support column 203 arranged on the mounting seat 201. The excitation unit 300 includes an excitation assembly 301 rotatably arranged on the support column 203 and abutting against the vibration assembly 202, a drive assembly 303 rotatably arranged on the support column 203, an energy storage assembly 302 that is rotatably arranged on the support column 203 and of which two ends are connected to the excitation assembly 301 and the drive assembly 303 respectively, and a snap-fit assembly 304 of which one end is rotatably arranged on the support column 203 and the other end is snap-fitted with the excitation assembly 301.

The vibration assembly 202 includes a connection seat 202a abutting against the blade 103 and snap-fitted with the mounting seat 201, a vibration spring 202b of which one end is arranged on the connection seat 202a, and a counterweight ball 202c arranged on the other end of the vibration spring 202b. The vibration spring 202b has elastic deformation. After being impacted, the vibration spring 202b converts one part of impact force into vibration and transmits the vibration to the connection seat 202a. The other part of the impact force directly acts on the blade 103 through the vibration spring 202b and the connection seat 202a. Thus, an ice-breaking effect can be improved, and anti-icing can be better implemented. In addition, due to configuration of the counterweight ball 202c, when the blade 103 rotates, the vibration spring 202b can also produce particular low-frequency vibration due to gravity of the counterweight ball 202c.

A slot 301c-2 for embedding a second snap-fit column 302c is provided in a first rotation sleeve 301c. Through the slot 301c-2, the second snap-fit column 302c can be stuck, and assembly is facilitated. A bearing recess 301c-3 for mounting a bearing is provided.

During use, the connection seat 202a abuts against the blade 103, and the mounting seat 201 is mounted on the blade 103, such that the connection seat 202a can keep a reliable connection with the blade 103. When the blade 103 rotates, the counterweight ball 202c is displaced under influence of gravity of the counterweight ball 202c, and the vibration spring 202b is elastically deformed, and thus generates low-frequency vibration. The vibration force is transmitted to the blade 103 through the connection seat 202a, such that a passive anti-icing operation can be implemented.

When the blade 103 rotates, the vibration assembly 202 is driven to move. Since the blade 103 changes in position, the support column 203 also changes in position, and the drive assembly 303 is constantly downward, and that is, keeps a vertical state. Thus, the drive assembly 303 can rotate relative to the support column 203, and the drive assembly 303 transmits, through the connection assembly 305, torque generated by rotation to the energy storage assembly 302. The excitation assembly 301 is stuck by the snap-fit assembly 304 and cannot rotate, such that the energy storage assembly 302 can store energy. The energy storage assembly 302 contracts and presses the snap-fit assembly 304 while storing the energy. When the snap-fit assembly 304 is completely pressed and contracted into the mounting recess 203a by the energy storage assembly 302, the snap-fit assembly 304 releases the excitation assembly 301 from limit, such that the excitation assembly 301 can rotate. Elastic potential energy stored in the energy storage module 302 drives the excitation assembly 301 to rotate, and the connection assembly 305 is blocked by an anti-reverse structure of the connection assembly, such that rotation of the connection assembly 305 can be avoided. When the excitation assembly 301 rotates, the excitation assembly impacts the counterweight ball 202c, and the counterweight ball 202c is subject to impact force, and transmits the impact force to the vibration spring 202b and the connection seat 202a. The vibration spring 202b generates high-frequency vibration, and a vibration frequency gradually decreases, such that the ice block on the blade 103 can be cleared, and an anti-icing objective is achieved.

When release of the energy stored in the vibration assembly 202 is completed, the vibration assembly 202 expands, and the snap-fit assembly 304 bounces and continues to be snapped in the snap-fit recess 301c-1, and fix the first rotation sleeve 301c, such that the excitation assembly 301 is in a fixed position. After the excitation assembly 301 is fixed, the energy storage assembly 302 is relatively fixed. Thus, when the drive assembly 303 rotates relatively, the energy storage operation can be implemented again through the connection assembly 305.

Through the automatic energy storage and release operations described above, impact and vibration can be automatically generated through the gravity potential energy of the drive assembly 303 without extra power, the ice block on the blade 103 can be cleared, and the anti-icing objective is achieved. Moreover, since the blade 103 has centrifugal force when rotating, a surface of the blade 103 is coated with a coating, and the vibration generated by the device is combined. Thus, icing on the blade 103 can be prevented, and the anti-icing objective is achieved.

Example 2 is a second example of the present disclosure. With reference to FIG. 1 to FIG. 10, this example is different from the first example in that an excitation assembly 301 includes a first rotation sleeve 301c rotatably arranged on a support column 203 and snap-fitted with a snap-fit assembly 304, a first support rod 301b of which one end is arranged on the first rotation sleeve 301c, and a hit hammer 301a arranged on the other end of the first support rod 301b and abutting against a counterweight ball 202c.

Further, a mounting recess 203a for accommodating the snap-fit assembly 304 is provided in the support column 203. A snap-fit recess 301c-1 in which the snap-fit assembly 304 is snap-fitted is provided in the first rotation sleeve 301c. The snap-fit assembly 304 includes a snap-fit strip 304a of which one end is arranged in the mounting recess 203a and the other end protrudes from the mounting recess 203a and that abuts against the snap-fit recess 301c-1, a first elastic member 304b arranged in the mounting recess 203a and abutting against the snap-fit strip 304a, and a pin 304c arranged on the snap-fit strip 304a and rotatably connected to the support column 203. The snap-fit strip 304a is located in a constant-force spring 302a and abuts against the constant-force spring.

The snap-fit strip 304a is supported by the pin 304c, such that the snap-fit strip 304a can rotate in the support column 203. The first elastic member 304b pushes the snap-fit strip 304a to turn over, and the snap-fit strip 304a is ejected from the mounting recess 203a. Thus, one end of the snap-fit strip 304a is snapped in the snap-fit recess 301c-1, the first rotation sleeve 301c is fixed, the first rotation sleeve 301c is prevented from rotation, and the energy storage operation can be implemented.

In use, when the energy storage assembly 302 is in an expanded state, the first elastic member 304b pushes the snap-fit strip 304a to turn over, and the snap-fit strip 304a is snapped in the snap-fit recess 301c-1, and fixes the snap-fit recess 301c-1. Then, when a drive assembly 303 rotates relatively, the energy storage assembly 302 may be driven to rotate and contract through a connection assembly 305, and implement the energy storage operation. When the energy storage assembly 302 contracts to press the snap-fit strip 304a in the mounting recess 203a, the snap-fit strip 304a slides down from the snap-fit recess 301c-1. The snap-fit strip 304a releases the first rotation sleeve 301c from limit, the energy storage assembly 302 drives the first rotation sleeve 301c to rotate, the first rotation sleeve 301c drives the first support rod 301b to rotate, and the first support rod 301b drives the hit hammer 301a to rotate. The hit hammer 301a hits the counterweight ball 202c, a vibration assembly 202 generates vibration and impact, and an ice block on the blade 103 can be vibrated and shattered, and the anti-icing operation is implemented. In addition, a larger ice block can be shattered into small ice blocks, such that the ice blocks fall off and melt conveniently.

The remaining structures are the same as structures of Example 1.

Example 3 is a third example of the present disclosure. With reference to FIG. 1 to FIG. 10, this example is different from the second example in that a drive assembly 303 includes a second rotation sleeve 303c rotatably arranged on a support column 203, a second support rod 303b of which one end is arranged on the second rotation sleeve 303c, and a counterweight block 303a arranged on the other end of the second support rod 303b.

Further, the energy storage assembly 302 includes a constant-force spring 302a arranged on a peripheral side of the support column 203 and located between an excitation assembly 301 and the drive assembly 303, a second snap-fit column 302c arranged on an end, closest to an inner side, of the constant-force spring 302a and connected to a first rotation sleeve 301c, and a first snap-fit column 302b arranged on the other end of the constant-force spring 302a and slidably connected to the second rotation sleeve 303c. When a connection assembly 305 rotates, the first snap-fit column 302b is driven to rotate relatively, and the first snap-fit column 302b drives the constant-force spring 302a to contract and store energy. Thus, an energy storage operation can be performed.

The connection assembly 305 is arranged between the energy storage assembly 302 and the second rotation sleeve 303c. The connection assembly 305 includes a rotation plate 305a rotatably arranged on the support column 203 and slidably connected to and abutting against the first snap-fit column 302b, two groups of anti-reverse teeth 305b meshing with and arranged on the rotation plate 305a, a baffle 305d arranged on the first snap-fit column 302b, and a second elastic member 305c that is arranged on the first snap-fit column 302b and of which two ends are connected to the baffle 305d and the rotation plate 305a respectively.

When the second rotation sleeve 303c rotates relatively around the support column 203, the rotation plate 305a is driven to rotate relatively through the anti-reverse teeth 305b. The anti-reverse teeth 305b having an inclined block structure can merely rotate the rotation plate 305a in one direction. Thus, the rotation plate can rotate when the second rotation sleeve 303c rotates relatively or swings, but does not rotate accordingly when the second rotation sleeve 303c resets. The second elastic member 305c pushes the rotation plate 305a to move, and the rotation plate 305a can move back and forth along with the anti-reverse teeth 305b during energy storage, thus achieving an anti-reverse objective. The first snap-fit column 302b slides relative to the rotation plate 305a, and space for the rotation plate 305a to move can be provided. When the rotation plate 305a rotates, the first snap-fit column 302b can be driven to rotate, and an energy storage operation can be performed on the constant-force spring 302a.

In use, due to influence of self-gravity of the counterweight block 303a, the counterweight block 303a always keeps downward in a vertical state. Thus, when the support column 203 is relatively displaced, the counterweight block 303a drives the second support rod 303b and the second rotation sleeve 303c to relatively rotate around the support column 203, the excitation assembly 301 is stuck by a snap-fit assembly 304, and the second snap-fit column 302c is in a relatively fixed state and cannot move. When the second rotation sleeve 303c rotates, the rotation plate 305a is driven to rotate. When the rotation plate 305a rotates, the first snap-fit column is driven 302b to rotate. When the first snap-fit column 302b rotates, the constant-force spring 302a is driven to contract and store energy, and the constant-force spring 302a can be contracted while storing the energy. When the constant-force spring 302a is contracted, a gap between the constant-force spring and the support column 203 is reduced. Thus, the constant-force spring 302a is pressed against the snap-fit assembly 304, and the snap-fit assembly 304 is pressed into a mounting recess 203a. The first rotation sleeve 301c is released from limit, and the first rotation sleeve 301c may rotate. The excitation assembly 301 is driven to rotate through the energy storage assembly 302, and the excitation assembly 301 is triggered to hit the vibration assembly 202, and generate vibration.

When the energy stored in the constant-force spring 302a is released, the constant-force spring 302a is expanded. The snap-fit assembly 304 can be ejected from the mounting recess 203a and continue to be stuck in the snap-fit recess 301c-1, to limit the snap-fit recess 301c-1. Thus functions of repeated automatic energy storage, release, impact, and reset can be implemented, and vibration can be automatically generated without additional a power element. Mounting at any position in or out of the blade 103 can be implemented, and mounting is convenient.

The remaining structures are the same as structures of Example 2.

Example 4 is a fourth example of the present disclosure. With reference to FIG. 1-FIG. 10, this example provides an anti-icing method. The anti-icing method is applied to the anti-icing device for a blade of a wind turbine generator system described above, and includes:
a mounting seat 201 is mounted on a blade 103, and a vibration assembly 202 is made to abut against the blade 103;
when the blade 103 rotates, a drive assembly 303 is rotated relative to a support column 203 since a center of gravity of the drive assembly 303 is always downward;
an excitation assembly 301 is made stuck by a snap-fit assembly 304, the excitation assembly 301 is displaced and rotated along with the support column 203, and an energy storage assembly 302 is driven by the drive assembly 303 to store energy;
the energy storage assembly is made to elastically contract and deform when the energy storage assembly 302 stores the energy, the snap-fit assembly 304 is pressed by the energy storage assembly 302, and the snap-fit assembly 304 is displaced and separated from the excitation assembly 301;
when the snap-fit assembly 304 releases the excitation assembly 301 from limit, the energy stored by the energy storage assembly 302 is released through the excitation assembly 301, and the excitation assembly 301 is enabled to rotate;
the vibration assembly 202 is hit by the excitation assembly 301 when the excitation assembly rotates, the vibration assembly 202 is made to generate vibration, the vibration is transmitted to the blade 103, the blade 103 is vibrated synchronously, an anti-icing objective is achieved, an ice block is shattered when icing occurs, and the ice is made to fall off conveniently;
when the energy storage assembly 302 releases the energy, the energy storage assembly is made to elastically expand and deform, the snap-fit assembly 304 is made to bounce and continue to limit the excitation assembly 301, and the energy storage assembly 302 is made capable of continuously performing storage; and
the steps are repeated, automatic vibration triggering is implemented, and a physical anti-icing operation is automatically performed by relying on gravitational potential energy generated when the blade 103 rotates.

The present disclosure can automatically store the energy. After the energy storage is completed, the impact vibration assembly 202 is automatically triggered and hit to generate the impact and the vibration, and can shatter the ice block on the blade 103. In addition, the ice block can fall off conveniently through the vibration.

The remaining structures are the same as structures of Example 3.

What is claimed is:

1. An anti-icing device for a blade of a wind turbine generator system, used for clearing ice on a wind turbine unit, comprising:
a vibration unit comprising a mounting seat arranged on the wind turbine unit, a vibration assembly arranged on the mounting seat, and a support column arranged on the mounting seat; and
an excitation unit comprising an excitation assembly rotatably arranged on the support column and abutting against the vibration assembly, a drive assembly rotatably arranged on the support column, an energy storage assembly that is rotatably arranged on the support column and of which two ends are connected to the excitation assembly and the drive assembly respectively, and a snap-fit assembly of which one end is rotatably arranged on the support column and the other end is snap-fitted with the excitation assembly.

2. The anti-icing device for a blade of a wind turbine generator system according to claim 1, wherein the wind turbine unit comprises a support seat, a rotation seat rotatably arranged on the support seat, and a blade arranged on the rotation seat and used for mounting the mounting seat.

3. The anti-icing device for a blade of a wind turbine generator system according to claim 2, wherein the vibration assembly comprises a connection seat abutting against the blade and snap-fitted with the mounting seat, a vibration spring of which one end is arranged on the connection seat, and a counterweight ball arranged on the other end of the vibration spring.

4. The anti-icing device for a blade of a wind turbine generator system according to claim 3, wherein the excitation assembly comprises a first rotation sleeve rotatably arranged on the support column and snap-fitted with the snap-fit assembly, a first support rod of which one end is arranged on the first rotation sleeve, and a hit hammer arranged on the other end of the first support rod and abutting against the counterweight ball.

5. The anti-icing device for a blade of a wind turbine generator system according to claim 4, wherein the drive assembly comprises a second rotation sleeve rotatably arranged on the support column, a second support rod of which one end is arranged on the second rotation sleeve, and a counterweight block arranged on the other end of the second support rod.

6. The anti-icing device for a blade of a wind turbine generator system according to claim 5, wherein the energy storage assembly comprises a constant-force spring arranged on a peripheral side of the support column and located between the excitation assembly and the drive assembly, a second snap-fit column arranged on an end, closest to an inner side, of the constant-force spring and connected to the first rotation sleeve, and a first snap-fit column arranged on the other end of the constant-force spring and slidably connected to the second rotation sleeve.

7. The anti-icing device for a blade of a wind turbine generator system according to claim 6, wherein a mounting recess for accommodating the snap-fit assembly is provided in the support column, a snap-fit recess in which the snap-fit assembly is snap-fitted is provided in the first rotation sleeve, the snap-fit assembly comprises a snap-fit strip of which one end is arranged in the mounting recess and the other end protrudes from the mounting recess and that abuts against the snap-fit recess, a first elastic member arranged in the mounting recess and abutting against the snap-fit strip, and a pin arranged on the snap-fit strip and rotatably connected to the support column, and the snap-fit strip is located in the constant-force spring and abuts against the constant-force spring.

8. The anti-icing device for a blade of a wind turbine generator system according to claim 7, wherein a connection assembly is arranged between the energy storage assembly and the second rotation sleeve, and the connection assembly comprises a rotation plate rotatably arranged on the support column and slidably connected to and abutting against the first snap-fit column, two groups of anti-reverse teeth meshing with and arranged on the rotation plate, a baffle arranged on the first snap-fit column, and a second elastic member that is arranged on the first snap-fit column and of which two ends are connected to the baffle and the rotation plate respectively.

9. The anti-icing device for a blade of a wind turbine generator system according to claim 8, wherein a slot for embedding the second snap-fit column is provided in the first rotation sleeve.

10. An anti-icing method, applied to the anti-icing device for a blade of a wind turbine generator system according to claim 9, comprising:
mounting a mounting seat on a blade, and making a vibration assembly abuts against the blade;
rotating, when the blade rotates, a drive assembly relative to a support column since a center of gravity of the drive assembly is always downward;
making an excitation assembly stuck by a snap-fit assembly, displacing and rotating the excitation assembly along with the support column, and driving, by the drive assembly, an energy storage assembly to store energy;
making the energy storage assembly elastically contract and deform when the energy storage assembly stores the energy, pressing the snap-fit assembly by the energy storage assembly, and displacing and separating the snap-fit assembly from the excitation assembly;
releasing, when the snap-fit assembly releases the excitation assembly from limit, the energy stored by the energy storage assembly through the excitation assembly, and enabling the excitation assembly to rotate;
hitting, by the excitation assembly when the excitation assembly rotates, the vibration assembly, making the vibration assembly generate vibration, transmitting the vibration to the blade, vibrating the blade synchronously, achieving an anti-icing objective, shattering an ice block when icing occurs, and making the ice fall off conveniently;
making, when the energy storage assembly releases the energy, the energy storage assembly elastically expands and deforms, making the snap-fit assembly bounce and continue to limit the excitation assembly, and making the energy storage assembly capable of continuously performing storage; and
repeating the steps, implementing automatic vibration triggering, and automatically performing a physical anti-icing operation by relying on gravitational potential energy generated when the blade rotates.
